(19) United States
(12) Patent Application Publication
(10) Pub. No.: US 2015/0079853 A1
(43) Pub. Date: Mar. 19, 2015

(54) ELECTRICAL CONNECTOR

(71) Applicant: Chou Hsien TSAI, Taipei Hsien (TW)

(72) Inventor: Chou Hsien TSAI, Taipei Hsien (TW)

(21) Appl. No.: 14/484,212

(22) Filed: Sep. 11, 2014

(30) Foreign Application Priority Data
Sep. 13, 2013 (CN) 201320570212.4
Oct. 21, 2013 (CN) 201320649544.1
Dec. 27, 2013 (CN) 201320895319.6

(51) Int. Cl. H01R 13/24

(52) U.S. Cl. CPC H01R 13/2442
USPC 439/751

(57) ABSTRACT

An electrical connector comprises a female base formed with a fitting slot; female terminals each arranged on one side of the female base and made of a metal sheet and integrally formed with an extension having a contact disposed in the fitting slot, a fixing portion fixed to the female base and a pin extending out of the female base; a male base mounted in the fitting slot; and male terminals each arranged on one side of the male base and made of a metal sheet and integrally formed with an extension having a contact elastically resting against the contact of the female terminal, a fixing portion fixed to the male base and a pin extending out of the male base. One of the male and female terminals is formed by bending a plate surface, and the fixing portions thereof are transversally fixed.

### BACKGROUND OF THE INVENTION

1. Field of the Invention

The invention relates to an electrical connector, and more particularly to a board-to-board electrical connector and an integrally injection molded electrical connector having elastically movable terminals embedded into a plastic base.

2. Related Art

Referring to FIGS. 1 and 2, a conventional board-to-board electrical connector includes a female base 10, female terminals 17, a male base 23 and male terminals 28.

The female base 10 has a middle portion 11 and a peripheral portion 12. The middle portion 11 and the peripheral portion 12 form two concave portions 13. The peripheral portion 12 has one row of vertical female terminal fixing slots 14, and one row of female terminal moving slots 15 are disposed on each of two sides of the middle portion 11.

The female terminals 17 is mounted on the female base 10 and is formed by pressing a metal sheet to have: a force arm 18, which is elastically movable in the female terminal moving slot 15 and has a contact point 19 projecting beyond the female terminal moving slot 15; a fixing portion 21, which extends from bottom to top and is inserted and fixed into the female terminal fixing slot 14; and a pin portion 20 horizontally extending out of the female base 10.

The middle of the male base 23 is formed with a concave portion 24. Each of two sides of the male base 23 is formed with one row of vertical male terminal slots 25. Two sides of the male base 23 are fit with two concave portions 13 of the female base 10, and the middle portion 11 of the female base is fit with the concave portion 24 at the middle of the male base.

The male terminals 28 is mounted in the male terminal slot 25 of the male base 23 and is formed by bending a metal sheet to have: a fixing portion 29 fixed to the male terminal slot 25; a contact sheet 30 connected to one end of the fixing portion 29 and stacked on the fixing portion 29, wherein the contact sheet 30 is formed with a convex portion 32; and a pin portion 31 connected to the other end of the fixing portion 29 and horizontally extending out of the male base 23.

As shown in FIG. 2, after the male base 23 is combined with the female base 10, the contact point 19 of the female terminal 17 is engaged and locked with the top of the convex portion 32 of the male terminal 28 to prevent the male base 23 and the female base 10 from being separated in a vertical direction. Thus, the pin portion 31 of the male terminal is connected to a first circuit board 33, and the pin portion 20 of the female terminal is connected to the second circuit board 34 so that the first circuit board 33 and the second circuit board 34 are electrically connected together.

The conventional electrical connectors still have the following drawbacks.

First, the fixing portions 29 and 21 of the male and female terminals are fixed to the male and female bases 23 and 10 in the vertical direction so that the requirement of the low-height electrical connector cannot be satisfied.

Second, the vertical engaging and locking between the male base 23 and the female base 10 are made through the male and female terminals, so the male and female terminals as well as the male and female bases are required to have the high manufacturing and assembling precision.

### SUMMARY OF THE INVENTION

A main object of the invention is to provide an electrical connector, in which the contacts of the male and female terminals are plate surfaces and cut surfaces vertically elastically rest against each other to achieve the excellent contact effect and ensure the electrical connection. In addition, the requirement of the assembling precision of the male and female terminals is low and can be easily manufactured.

Another main object of the invention is to provide an electrical connector having male and female terminals formed by bending the plate surface, and fixing portions transversally and horizontally fixed with the male and female bases, so that the low-height requirement of the male and female bases can be satisfied.

Still another main object of the invention is to provide an electrical connector, in which the engaging structure facilitates the direct engagement between the male and female bases, and the male and female terminals only provide the conducting function without mutual engaging, so that the male and female terminals are simpler and can be easily manufactured and assembled.

Yet still another main object of the invention is to provide an electrical connector an electrical connector, in which the base can be embedded into and integrally injection molded with the elastically movable terminal, and the extension of the elastically movable terminal is combined with the base to achieve the strengthening effect.

To achieve the above-identified objects, the invention provides an electrical connector, comprising: a female base, which is an insulation material and has a middle formed with a depressed fitting slot; female terminals arranged on at least one side of the female base, wherein the female terminal is made of a metal sheet and integrally formed with an extension, a fixing portion and a pin, the fixing portion is fixed to the female base, the extension has a contact disposed in the fitting slot, and the pin extends out of the female base; a male base, which is made of an insulation material and mounted in the fitting slot of the female base; and male terminals arranged on at least one side of the male base, wherein the male terminal is made of a metal sheet and integrally formed with an extension, a fixing portion and a pin, the fixing portion is fixed to the male base, the extension has a contact elastically resting against the contact of the female terminal, and the pin extends out of the male base. Elastic resting between a plate surface and a cut surface is present between the contacts of the male and female terminals, one of the contacts of the male and female terminals is the plate surface, the other of the contacts of the male and female terminals is the cut surface, one end of the extension of one of the male and female terminals is connected to one end of the fixing portion of the terminal, the other end of the terminal extends to the fitting slot of the female base, and the extension is elastically and vertically movable, and has an end section formed with the contact, which is vertically projecting.

The invention further provides an electrical connector, comprising: a female base, which is made of an insulation material and has a middle formed with a fitting slot; female terminals arranged on at least one side of the female base, wherein the female terminal is made of a metal sheet and integrally formed with an extension, a fixing portion, and a pin, the fixing portion is fixed to the female base, the extension has a contact disposed in the fitting slot, and the pin extends out of the female base; a male base is made of an insulation material and mounted in the fitting slot of the female base; and male terminals arranged on at least one side of the male base, wherein the male terminal is made of a metal sheet and integrally formed with an extension, a fixing portion and a pin, the fixing portion is fixed to the male base, the extension has a contact elastically resting against the contact of the female terminal, and the pin extends out of the male base. At least one of the male and female terminals is formed by bending a plate surface and has the fixing portion transversally fixed.

The invention further provides an electrical connector, comprising: a female base, which is made of an insulation material and has a middle formed with a fitting slot; female terminals arranged on at least one side of the female base, wherein the female terminal is made of a metal sheet and integrally formed with an extension, a fixing portion and a pin, the fixing portion is fixed to the female base, the extension has a contact disposed in the fitting slot, and the pin extends out of the female base; a male base, which is made of an insulation material and mounted in the fitting slot of the female base; male terminals arranged on at least one side of the male base, wherein the male terminal is made of a metal sheet and integrally formed with an extension, a fixing portion and a pin, the fixing portion is fixed to the male base, the extension has a contact elastically resting against the contact of the female terminal, and the pin extends out of the male base; and an engaging structure, which makes the male base be combined with and engaged with the female base so that the contact of the male terminal elastically rests against the contact of the female terminal. The engaging structure has a first engaging portion on two sides of the male base, and is integrally formed with a second engaging portion on two sides of the fitting slot of the female base, the first and second engaging portions are a transversal projection and a concave portion engaging with each other, the contact of the male terminal is disposed on an inner side of the first engaging portion, and the contact of the female terminal is disposed on an inner side of the second engaging portion.

The invention further provides an electrical connector, comprising: a base, which is made of an insulation material and has a fitting slot; and terminals arranged on the base, wherein the terminal is formed by bending a metal sheet and is integrally formed with an extension, a fixing portion and a pin, wherein the fixing portion is fixed to the base, the extension is connected to one end of the fixing portion and has a projecting contact disposed in the fitting slot, and the pin is connected to the other end of the fixing portion and extends out of the base. The fixing portions of at least one row of terminals are embedded into the base and are integrally injection molded, the extensions of the one row of terminals have first portions and second portions, the first portions extend transversally, one end of the first portion is connected to one end of the fixing portion, the other end of the first portion is embedded into the base and fixed, the second portion extends to the fitting slot and vertically corresponds to the first portion, the second portion is elastically movable and has the contact, and the base has an empty region above the first portion vertically corresponding to an elastically movable portion of the second portion.

The invention has the following characteristics and advantages.

First, the contacts of the male and female terminals vertically elastically rest against each other and are a plate surface and a cut surface elastic resting against each other. So, the excellent contact effect is obtained to ensure the electrical connection. In addition, the requirement of the assembling precision of the male and female terminals is low and the product can be easily manufactured.

Second, the male and female terminals are formed by bending the plate surface and have fixing portions transversally and horizontally fixed with the male and female bases. Thus, the low-height requirement on the male and female bases can be satisfied.

Third, the engaging structure facilitates the direct engagement between the male and female bases, and the male and female terminals only provide the conducting function without mutual engaging, so that the male and female terminals are simpler and can be easily manufactured and assembled.

Fourth, the base can be embedded into and integrally injection molded with the elastically movable terminals, and the extensions of the elastically movable terminals are combined with the base to achieve the strengthening effect.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a decomposed schematic cross-sectional view showing a conventional electrical connector.

FIG. 2 is a schematically cross-sectional view showing a used state of a conventional electrical connector.

FIG. 3 is an exploded cross-sectional side view showing male and female connectors according to the first embodiment of the invention.

FIG. 4 is an assembled cross-sectional side view showing the male and female connectors according to the first embodiment of the invention.

FIG. 5 is a pictorially exploded view showing the male and female connectors according to the first embodiment of the invention.

FIG. 6 is an exploded cross-sectional side view showing male and female connectors according to the second embodiment of the invention.

FIG. 7 is an assembled cross-sectional side view showing the male and female connectors according to the second embodiment of the invention.

FIG. 8 is an exploded cross-sectional side view showing male and female connectors according to the third embodiment of the invention.

FIG. 9 is an assembled cross-sectional side view showing the male and female connectors according to the third embodiment of the invention.

FIG. 10 is an exploded cross-sectional side view showing male and female connectors according to the fourth embodiment of the invention.

FIG. 11 is an assembled cross-sectional side view showing the male and female connectors according to the fourth embodiment of the invention.

FIG. 12 is an exploded cross-sectional side view showing male and female connectors according to the fifth embodiment of the invention.

FIG. 13 is an assembled cross-sectional side view showing the male and female connectors according to the fifth embodiment of the invention.

FIG. 14 is a pictorially exploded view showing male and female connectors according to the sixth embodiment of the invention.

FIG. 15 is an exploded cross-sectional side view showing the male and female connectors according to the sixth embodiment of the invention.

FIG. 16 is an assembled cross-sectional side view showing the male and female connectors according to the sixth embodiment of the invention.

FIG. 17 is a pictorial view showing the female terminal according to the sixth embodiment of the invention.

FIG. 18 is a pictorially exploded view showing the male and female connectors according to the seventh embodiment of the invention.

FIG. 19 is an exploded cross-sectional side view showing male and female connectors according to the seventh embodiment of the invention.

FIG. 20 is an assembled cross-sectional side view showing the male and female connectors according to the seventh embodiment of the invention.

FIG. 21 is a pictorial view showing the female terminal according to the seventh embodiment of the invention.

FIG. 22 is a pictorially exploded view showing the male and female connectors according to the eighth embodiment of the invention.

FIG. 23 is an exploded cross-sectional side view showing the male and female connectors according to the eighth embodiment of the invention.

FIG. 24 is an assembled cross-sectional side view showing the male and female connectors according to the eighth embodiment of the invention.

FIG. 25 is a pictorial view showing the female terminal according to the eighth embodiment of the invention.

FIG. 26 is a pictorial view showing the male terminal according to the eighth embodiment of the invention.

FIG. 27 is a pictorial view showing the male connector according to the eighth embodiment of the invention.

FIG. 28 is a pictorial view showing the female connector according to the eighth embodiment of the invention.

FIG. 29 is an exploded cross-sectional side view showing the male and female connectors according to the ninth embodiment of the invention.

FIG. 30 is an assembled cross-sectional side view showing the male and female connectors according to the ninth embodiment of the invention.

FIG. 31 is an assembled cross-sectional side view showing the female connector of the ninth embodiment of the invention connected to the conventional male connector.

FIG. 32 is an assembled cross-sectional side view showing the male connector of the ninth embodiment of the invention connected to the conventional female connector.

FIG. 33 is an exploded cross-sectional side view showing the male and female connectors according to the tenth embodiment of the invention.

FIG. 34 is an exploded cross-sectional side view showing the male and female connectors according to the eleventh embodiment of the invention.

FIG. 35 is an exploded cross-sectional side view showing the male and female connectors according to the twelfth embodiment of the invention.

FIG. 36 is a pictorial view showing the female terminal according to the twelfth embodiment of the invention.

FIG. 37 is an exploded cross-sectional side view showing the male and female connectors according to the 13th embodiment of the invention.

FIG. 38 is a pictorial view showing the male connector according to the 14th embodiment of the invention.

FIG. 39 is a cross-sectional side view showing the female connector according to the 15th embodiment of the invention.

FIG. 40 is a pictorially exploded view showing the 16th embodiment of the invention.

FIG. 41 is a pictorially assembled view showing the 16th embodiment of the invention.

FIG. 42 is a pictorial view showing the upper metal cover according to the 16th embodiment of the invention.

FIG. 43 is a cross-sectional side view (the position of the terminal 100′) according to the 16th embodiment of the invention.

FIG. 44 is a cross-sectional side view (the position of the terminal 100) showing the used state according to the 16th embodiment of the invention.

FIG. 45 is a cross-sectional side view showing the used state according to the 16th embodiment of the invention.

FIG. 46 is a pictorially exploded view according to the 17th embodiment of the invention.

FIG. 47 is a pictorial cross-sectional view according to the 17th embodiment of the invention.

FIG. 48 is a cross-sectional side view (the position of the terminal 100′) according to the 17th embodiment of the invention.

FIG. 49 is a cross-sectional side view (the position of the sliding slot 95) according to the 17th embodiment of the invention.

FIG. 50 is a cross-sectional side view showing a used state according to the 17th embodiment of the invention.

FIG. 51 is an exploded cross-sectional side view showing the male and female connectors according to the 18th embodiment of the invention.

FIG. 52 is a pictorially exploded view according to the 19th embodiment of the invention.

FIG. 53 is a cross-sectional side view (the position of the terminal 100′) according to the 19th embodiment of the invention.

FIG. 54 is a cross-sectional side view (the position of the terminal 100) according to the 20th embodiment of the invention.

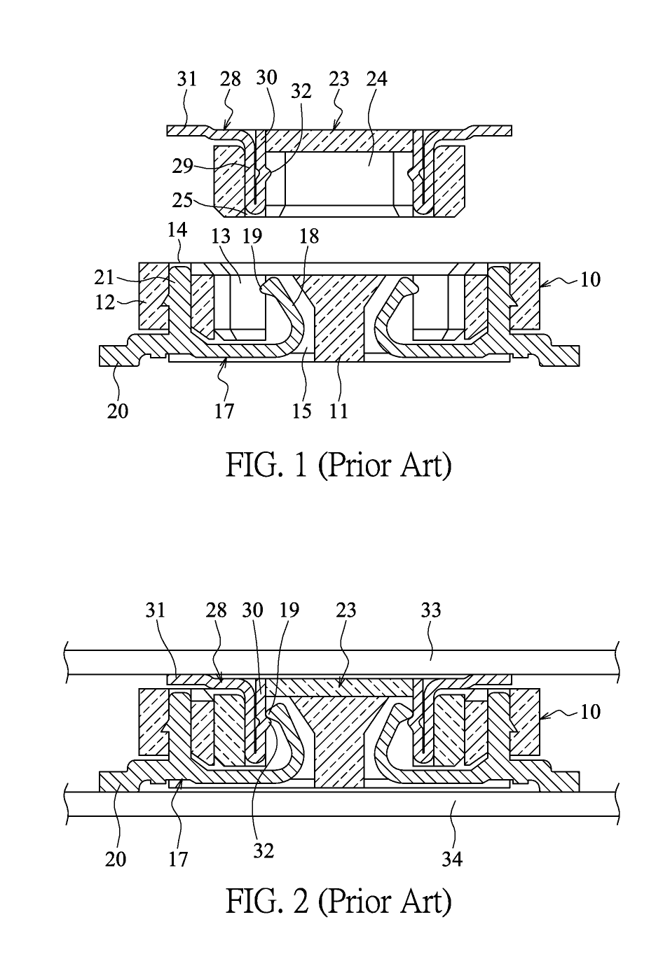

### DETAILED DESCRIPTION OF THE INVENTION

The present invention will be apparent from the following detailed description, which proceeds with reference to the accompanying drawings, wherein the same references relate to the same elements.

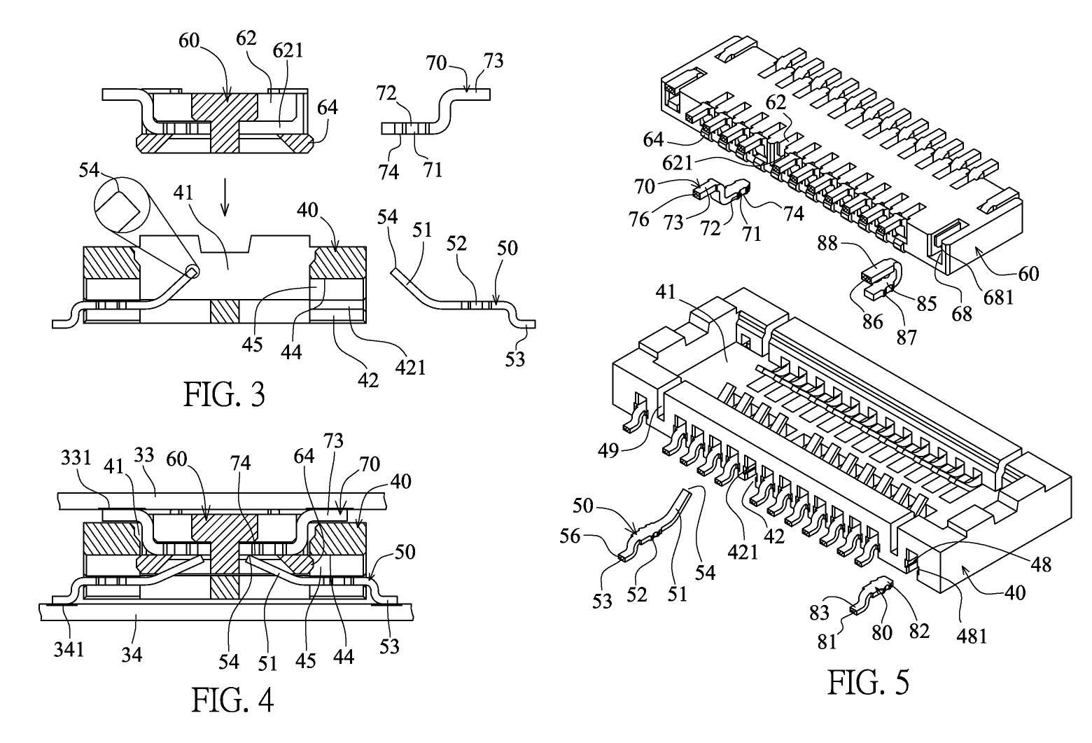

Referring to FIGS. 3 to 5, the first embodiment of the invention is a board-to-board electrical connector including a female base 40, female terminals 50, a male base 70, male terminals 80, four female lugs 80, four male lugs 85 and an engaging device.

The female base 40 is an insulating plastic material and has a middle formed with a depressed fitting slot 41, which is a single slot. One row of female terminal slots 42 are disposed on each of two sides of the fitting slot 41. The female terminal slot 42 has a transversal and horizontal fixing slot 421. A transversal fitting concave portion 45 is present above the fixing slot 421. The concave portion 45 has a top engaging surface 44. Each of two outer ends of one row of female terminal slots 42 on one side of the female base 40 is formed with a vertically extending groove 49. The outer end of the groove 49 is formed with a female lug slot 48. The female lug slot 48 has a transversally and horizontally extending fixing slot 481.

The female terminals 50 in two rows are separately arranged in two rows of female terminal slots 42 on two sides of the female base 40 to form a female connector. The female terminal 50 is formed by bending the plate surface of the metal sheet and is integrally formed with an extension 51, a fixing portion 52 and a pin 53. The fixing portion 52 transversally and horizontally extends. A projecting barb is formed on each of two sides of the fixing portion 52 and is horizontally fixed to the fixing slot 421 of the female terminal slot 42. One end of the extension 51 is connected to one end of the fixing portion 52 and is inclined and extends upwards so that the distal end extends to the fitting slot 41 of the female base 40. The extension 51 is an inclined force arm, is elastically and vertically movable and has a distal-end cut surface, which is most convex upward contact 54. The contact 54 is a natural arc or a deburred chamfer formed upon pressing. The pin 53 is connected to the other end of the fixing portion 52 and has a horizontal end section, wherein the pins 53 of the two rows of female terminals extend out of two sides of the female base 40, respectively.

The male base 60 is made of an insulating plastic material and is in the form of a single convex portion mounted in the fitting slot 41 of the female base 40. Each of two sides of the male base 60 is formed with one row of male terminal slots 62. The male terminal slot 62 has a transversally and horizontally extending fixing slot 621. Each of two outer ends of the one row of male terminal slots 62 has a male lug slot 68, which has a transversally and horizontally extending fixing slot 681.

The male terminals 70 in two rows are separately arranged in two rows of male terminal slots 62 of the male base 60 to form a male connector. The male terminal 70 is formed by bending the plate surface of the metal sheet, and is integrally formed with an extension 71, a fixing portion 72 and a pin 73. The extension 71 has a transversally and horizontally extending horizontal section. Two sides of the horizontal section have the fixing portion 72. The fixing portion 72 is a projecting barb. The bottom plate surface of the horizontal section is the contact 74. The fixing portion 72 and the fixing slot 621 of the male terminal slot are horizontally fixed, so the extension 71 is not elastically movable. The contact 74 elastically rests against the contact 54 of the female terminal 50. The pin 73 is connected to the extension 71 and has a horizontal end section, wherein the pins 73 of the two rows of male terminals extend out of two sides of the male base 60, respectively.

The contacts 74 and 54 of the male and female terminals are the only mutual contacting and conducting portions of the male and female terminals.

The female lug 80 has a fixing portion 82 and a pin 83. The fixing portion 82 transversally and horizontally extends. The fixing portion 82 and the fixing slot 481 of the female lug slot 48 are horizontally fixed. The pin 83 is connected to one end of the fixing portion 82 and has an end section horizontally extending out of the female base 40. The structure of the female lug 80 is completely the same as the fixing portion 52 and the pin 53 of the female terminal 50.

The male lug 85 has a fixing portion 87 and a pin 88. The fixing portion 87 transversally and horizontally extends. The fixing portion 87 and the fixing slot 681 of the male lug slot 68 are horizontally fixed, and the pin 88 is connected to one end of the fixing portion 87 and has an end section horizontally extending out of the male base 60.

The engaging structure makes the male base 60 engage with the female base 40 so that the contact 74 of the male terminal 70 elastically rests against the contact 54 of the female terminal 50. The engaging structure is integrally formed with first engaging portions on two sides of the bottom end of the male base 40, and integrally formed with second engaging portions on two sides of the fitting slot 41 of the female base 40. The first and second engaging portions are transversal projections engaging with the concave portions. The first engaging portions are transversal projecting projections 64. The projections 64 vertically correspond to the one row of male terminals 70. The top and bottom ends of the projection 64 are formed with bevel guides. The second engaging portions are the transversal fitting concave portions 45. The concave portion 45 is formed in the female terminal slot, and is in the transversally penetrating through state.

As shown in FIG. 4, when the male base 60 is combined with the female base 40, the contact 74 of the male terminal 70 elastically rests against the contact 54 of the female terminal 50. The projections 64 of the male base 60 are engaged with the concave portions 45 of the female base 40 to prevent the male and female bases 60 and 40 from separating from each other. As shown in FIG. 5, the female base 40 has grooves 49, which make two side portions of the fitting slot 41 be easily elastically movable to facilitate the projections 64 of the male base 60 in engaging into the concave portions 45 of the female base 40.

The pins 73 of the male terminals 70 are electrically connected to the bonding pads 331 of the first circuit board 33, and the pins 53 of the female terminals 50 are electrically connected to the bonding pads 341 of the second circuit boards 34, so that the first circuit board 33 is electrically connected to the second circuit board 34.

Upon manufacturing, one row of female terminals 50 and two female lugs 80 are formed by pressing the same metal sheet, and one row of male terminals 70 and two male lugs 85 are formed by pressing the same metal sheet. So, as shown in FIG. 5, the platingless layer sections 81 of the distal ends of the pins of the two female lugs 80 and the platingless layer sections 56 of the distal ends of the pins of one row of female terminals 50 on the same side have the same height, and the platingless layer sections 86 of the distal ends of the pins of the two male lugs 85 and the platingless layer sections 76 of distal ends of the pins of the one row of male terminals 70 on the same side have the same height.

According to the above-mentioned descriptions, the embodiment can be concluded as having the following features and advantages.

First, the contacts of the male and female terminals vertically elastic rest against each other, and the elastic resting is present between the plate surface and the cut surface. So, the excellent contact effect is obtained to ensure the electrical connection.

Second, the male and female terminals 70 and 40 are formed by bending the plate surface and the fixing portions 72 and 42 thereof are transversally and horizontally fixed to the male and female bases 60 and 40. Thus, the low-height requirement of the male and female bases 60 and 40 can be satisfied.

Third, the male and female bases can be easily and directly engaged with each other, and the male and female terminals only have the conducting function without mutual engaging so that the male and female terminals become simpler and can be easily manufactured and assembled.

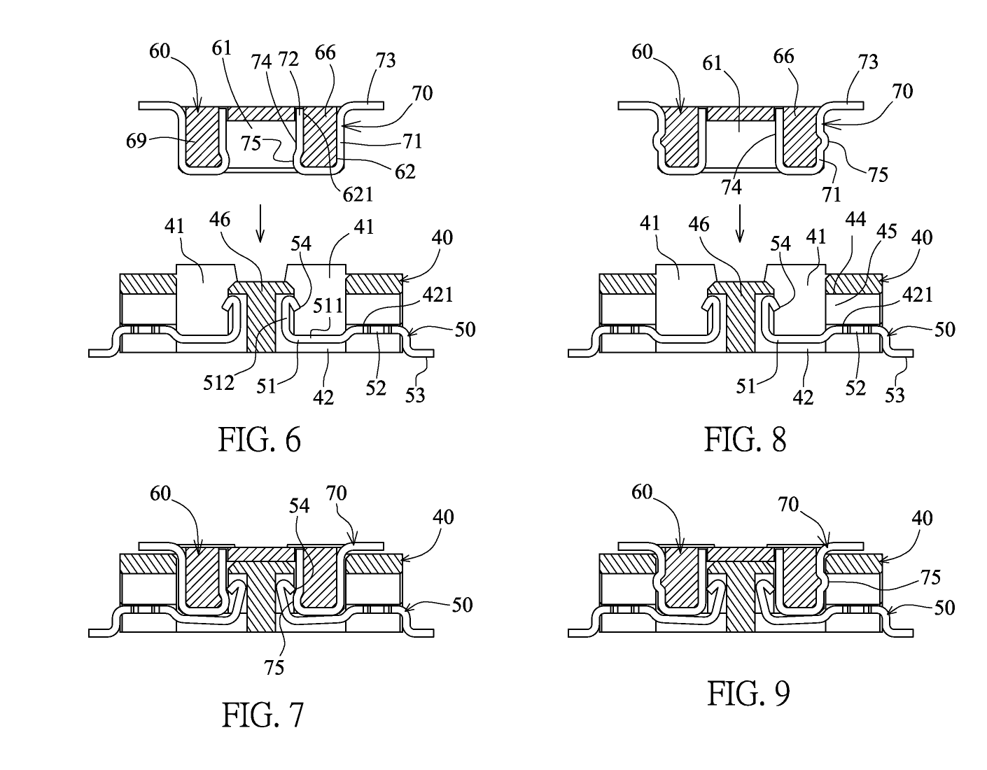

As shown in FIGS. 6 and 7, the second embodiment of the invention is substantially the same as the first embodiment except that the middle of the female base 40 of this embodiment has a projecting middle portion 46 so that the fitting slot 41 includes two concave portions on two sides of the middle portion. The female terminal slot 42 extends to the middle portion 46. The middle of the male base 60 has a concave portion 61 so that two sides are formed with convex portions 69. The concave portion 61 of the male base corresponds to the middle portion 46 of the female base 40. The convex portion 69 on two sides of the male base is correspondingly fit with the fitting slot 41 of the two concave portions of the female base. The extension of the female terminal 51 has a horizontal force arm 511 and a laterally and elastically movable force arm 512. The horizontal force arm 511 has one end connected to the fixing portion 52, and the other end extending to the middle portion 46 of the female base 40. The laterally and elastically movable force arm 512 is connected to the horizontal force arm 511 and extends vertically upwards. The plate surface of the distal section of the laterally and elastically movable force arm 512 is bent reversely downwards and slantingly projects toward the fitting slot 41. The cut surface of the distal end of the extension 51 is the contact 54.

The male terminal slot 62 of the male base has a vertically extending fixing slot 621. The extension 71 of the male terminal 70 is substantially formed by bending the plate surface into the U shape. The vertical front section of the inner side of the extension 71 is the contact 74, and the tail section is the fixing portion 72. The contact 74 laterally communicates with the concave portion 61. The male terminal 70 is assembled from bottom to top, and the fixing portion 72 thereof is fixed to the vertical fixing slot 621.

In addition, the extension 71 of the male terminal 70 has a convex portion 75 projecting beyond the inner side of the convex portion 69, as shown in FIG. 7. When the male base 60 is combined with female base 40, the convex portion 75 of the male terminal 70 may be engaged with and below the contact 54 of the female terminal 50, and the laterally and elastically movable force arm 512 of the female terminal 50 is elastically and inwardly movable.

As shown in FIGS. 8 and 9, the third embodiment of the invention is substantially the same as the second embodiment except that the extension 71 of the male terminal 70 of this embodiment has the convex portion 75 projecting beyond the outer side of the convex portion 69. When the male base 60 is combined with female base 40, the convex portion 75 of the male terminal 70 is engaged with the concave portion 45 of the female base 40.

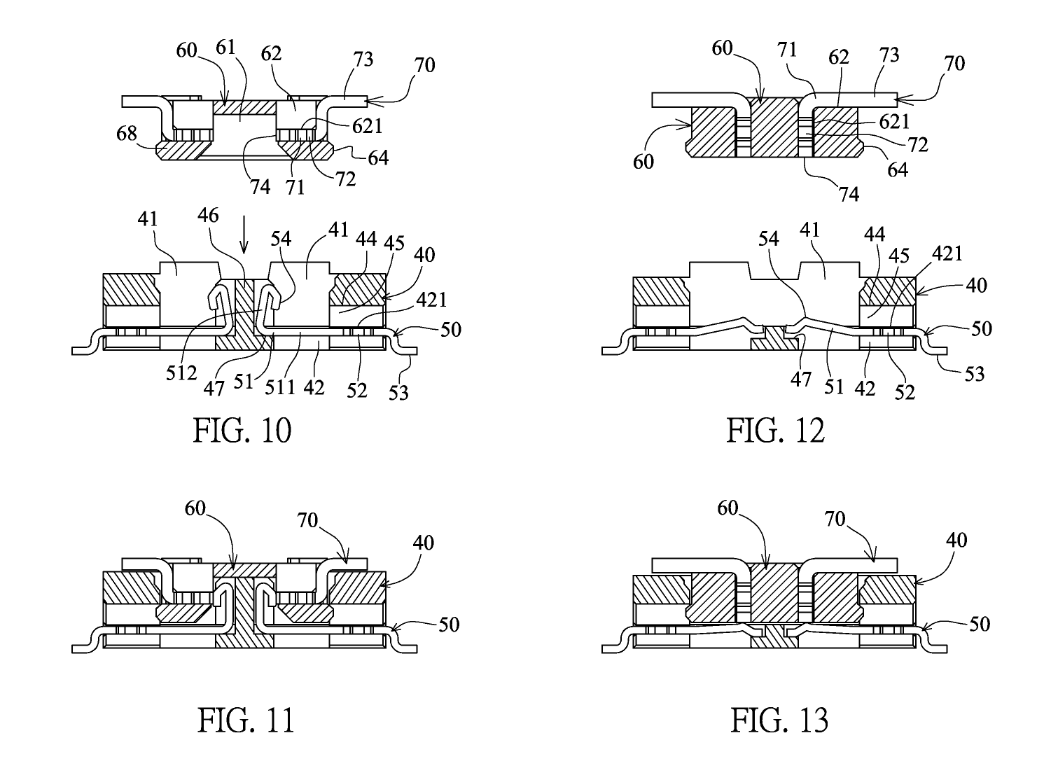

As shown in FIGS. 10 and 11, the fourth embodiment of the invention is substantially the same as the third embodiment except that the fixing portion 72 of the male terminal 70 of this embodiment is similar to the first embodiment and transversally and horizontally extends and is fixed to the fixing slot 621, the cut surface of the distal end of the extension 71 is the vertical contact 74, which laterally communicates with the concave portion 61. The plate surface of the distal section of the laterally and elastically movable force arm 512 of the extension 51 of the female terminal 50 is bent reversely downwards and slantingly projects toward the fitting slot 41, and the plate surface is again bent to form the contact 54. The contact 54 is a slightly inclined flat surface. When the contact 74 of the male terminal 70 laterally elastic rests against the contact 54 of the female terminal, the laterally and elastically movable force arm 512 of the female terminal is elastically and inwardly movable so that the contact 54 is turned into the vertical surface and contacts with the contact 74 of the male terminal 70 with the larger area.

In addition, each of two sides of the bottom of the middle portion 46 of the female base 40 has a limiting surface 47. The horizontal force arm 511 of the female terminal 50 rests against and is positioned on the limiting surface 47.

This embodiment further has the following technological features. That is, the contact 74 of the male terminal 70, which is not elastically movable, is the rougher cut surface having the better scratching effect. The contact 74 of the elastically movable female terminal 50 is the smooth plate surface. The electrically connection effect between the cut surface and the smooth plate surface is the best.

As shown in FIGS. 12 and 13, the fifth embodiment of the invention is substantially the same as the first and fourth embodiments except that the male terminal slot of the male base 60 of this embodiment has the vertically extending fixing slot 621. The contact 54 of the female terminal 50 is a bump formed by bending the plate surface. The distal end of the extension 51 can rest against the limiting surface 47. The male terminal 70 is also formed by bending the plate surface of the metal sheet, and is integrally formed with an extension 71, a fixing portion 72 and a pin 73. The extension 71 has the vertically extending vertical section, and two sides of the vertical section are formed with the fixing portion 72. The cut surface of the distal end of the vertical section is the contact 74. The fixing portion 72 is vertically fixed, from top to bottom, to the fixing slot 621 of the male terminal slot. So, the extension is not elastically movable. The contact 74 is exposed from the bottom end of the male base 60 and vertically elastically rests against the contact 54 of the female terminal 50. The pin 73 is connected to the extension 71 and has the end section horizontally extending out of the male base 60.

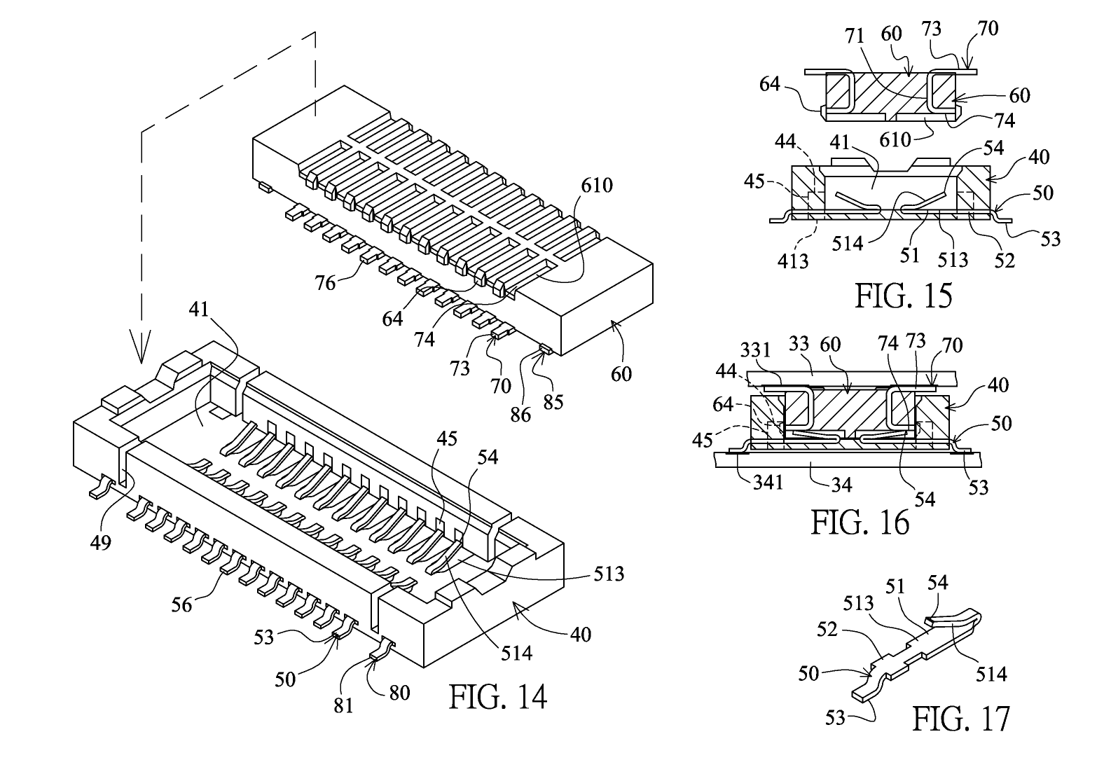

As shown in FIGS. 14 to 17, the sixth embodiment of the invention is a board-to-board electrical connector comprising a female base 40, female terminals 50, a male base 70, male terminals 80, four female lugs 80, four male lugs 85 and an engaging device.

The female base 40 is made of an insulating plastic material and has a middle formed with depressed fitting slot 41, wherein the fitting slot 41 is a single slot.

The female terminals 50 in two rows are arranged on two sides of the fitting slot 41 of the female base 40 to form a female connector. Each female terminal 50 is partially embedded into the female base 40 and integrally injection molded. The female terminal 50 is formed by bending the plate surface of the metal sheet and integrally formed with an extension 51, a fixing portion 52 and a pin 53. The fixing portion 52 transversally and horizontally extends and is embedded into the female base and fixed. The extension 51 has a first portion 513 and a second portion 514. One end of the first portion 513 is connected to one end of the fixing portion 52 and transversally and horizontally extends to the transversal middle point of the female base. The second portion 514 is bent reversely from the other end of the second portion 513, and is inclined and extends upwards to the fitting slot 41. One end of the first portion 513 connected to the second portion 514 is fixed to the female base 50, and the connection ends of the first and second portions are stacked. The reversely bent second portion 514 is an inclined force arm, which is elastically and vertically movable and has a distal-end cut surface, which is most convex upwards contact 54. The contact 54 is the natural arc or deburred chamfer formed upon pressing. The female base has an empty region above the first portion 513 vertically corresponding to the elastically movable portion of the second portion 514. The maximum width of the first portion 513 is greater than the maximum width of the second portion 514. The first portion 513 can vertically completely cover the elastically movable portion of the second portion 514. Two sides of the first portion 513 is covered by the material of the female base so that the empty region is formed with a bottom surface and is flush with the first portion 513. The bottom surface of the empty region is the bottom surface of the fitting slot 41. The pin 53 has a horizontal end section, and the pins 53 of the two rows of female terminals extend out of two sides of the female base 40, respectively.

The male base 60 is made of an insulating plastic material and is a single convex portion mounted in the fitting slot 41 of the female base 40. Each of two sides of the bottom surface of the male base 60 is formed with one row of slots 610.

The male terminals 70 in two rows are arranged on two sides of the male base 60 to form a male connector. Each male terminal 70 is partially embedded into the male base and is integrally injection molded. The male terminal 70 is formed by bending the plate surface of the metal sheet, and is integrally formed with an extension 71 and a pin 73. The extension 71 has a U shape. The extension 71 is also the fixing portion and substantially partially embedded into the male base 60 and fixed with only the top and bottom plate surfaces being exposed. So, the extension 71 is not elastically movable, and the bottom plate surface of the horizontal section of the bottom end is the contact 74, which is exposed and flush with the bottom surface of the slot 610. The contact 74 vertically elastically rests against the contact 54 of the female terminal 50. The pin 73 is connected to the extension 71 and has a horizontal end section, and the pins of the two rows of male terminals extend out of two sides of the male base 60.

The contacts 74 and 54 of the male and female terminals are the only mutual contacting and conducting portions of the male and female terminals.

The four female lugs 80 are fixed to two sides of the female base 40 and are disposed on the outer ends of the two rows of female terminals 50. The female lug 80 has a fixing portion and a pin, and is substantially the same as the fixing portion and the pin of the female terminal. The fixing portion also transversally and horizontally extends and is embedded into the female base 40 and fixed. The end section of the pin also horizontally extends out of the female base 40.

The four male lugs 85 are fixed to two sides of the male base 60 and disposed on the outer ends of the two rows of male terminals 70. The male lug 85 has a fixing portion and a pin and is substantially the same as the fixing portion and the pin of the male terminal. The fixing portion vertical extends and is embedded into the male base 60 and fixed. The pin also horizontally extends out of the male base 60.

The engaging structure makes the male base 60 be combined and engaged with the female base 40, so that the contact 74 of the male terminal 70 elastically rests against the contact 54 of the female terminal 50. The engaging structure is integrally formed with the first engaging portion on two sides of the bottom end of the male base 60, and integrally formed with the second engaging portion on two sides of the fitting slot 41 of the female base 40. The first and second engaging portions are transversal projections engaging with the slots. The first engaging portion comprises transversal projecting projections 64. The top and bottom ends of the projection 64 are formed with bevel guides. The projections 64 are transversal and vertically correspond to the gaps between the adjacent male terminals 70. The male base 60 is vertically staggered with the projections 64. The second engaging portion comprises the transversal fitting concave portions 45. The concave portions 45 are transversal and vertically correspond to the gaps between the adjacent female terminals 50. The top vertically corresponding to the concave portion 45 has the top engaging surface 44 and the bottom surface of the lower corresponding female base is formed with through holes 413.

As shown in FIG. 16, when the male base 60 is combined with female base 40, the contact 74 of the male terminal 70 vertically and elastically rests against the contact 54 of the female terminal 50, the projections 64 of the male base 60 are engaged with the concave portions 45 of the female base 40 to prevent the male and female bases 60 and 40 from separating from each other. As shown in FIG. 14, each of two outer ends of the one row of female terminals 50 on two sides of the female base 40 has a vertically extending groove 49. The groove 49 can make the two side portions of the fitting slot 41 be easily and elastically movable to facilitate the projections 64 of the male base 60 in engaging with the concave portions 45 of the female base 40.

The pins 73 of the male terminals 70 are electrically connected to the bonding pad 331 of the first circuit board 33. The pins 53 of the female terminals 50 are electrically connected to the bonding pads 341 of the second circuit boards 34 so that the first circuit board 33 is electrically connected to the second circuit board 34.

Upon manufacturing, the male and female terminals and the male and female lugs are pressed in the manner the same as that of the first embodiment. So, the platingless layer section 81 of the female lug 80 and the platingless layer section 56 of the female terminal 50 have the same height, and the platingless layer section 86 of the male lug 85 and the platingless layer section 76 of the male terminal 70 have the same height.

According to the above-mentioned description, this embodiment has the advantages of the first embodiment and the following additional advantages.

First, the bottom surface of the fitting slot 41 has the better structural strength by the combination of the first portion 513 of the extension of the female terminals 50, so that the small sized plastic base having the better structural strength can be provided.

Second, the first portion 513 of the extension of the female terminal 50 can completely cover the elastically movable portion of the second portion 514 in the vertical direction, and the concave portions 45 transversally and vertically corresponds to the gaps between the adjacent female terminals 50. Also, the top of the concave portion 45 has the top engaging surface, and the bottom thereof corresponding the bottom surface of the female base 40 is formed with through holes 413. So, the female base 40 can be directly injected molded using the top and bottom molds combined together without using the slider. The manufacturing processes are simplified.

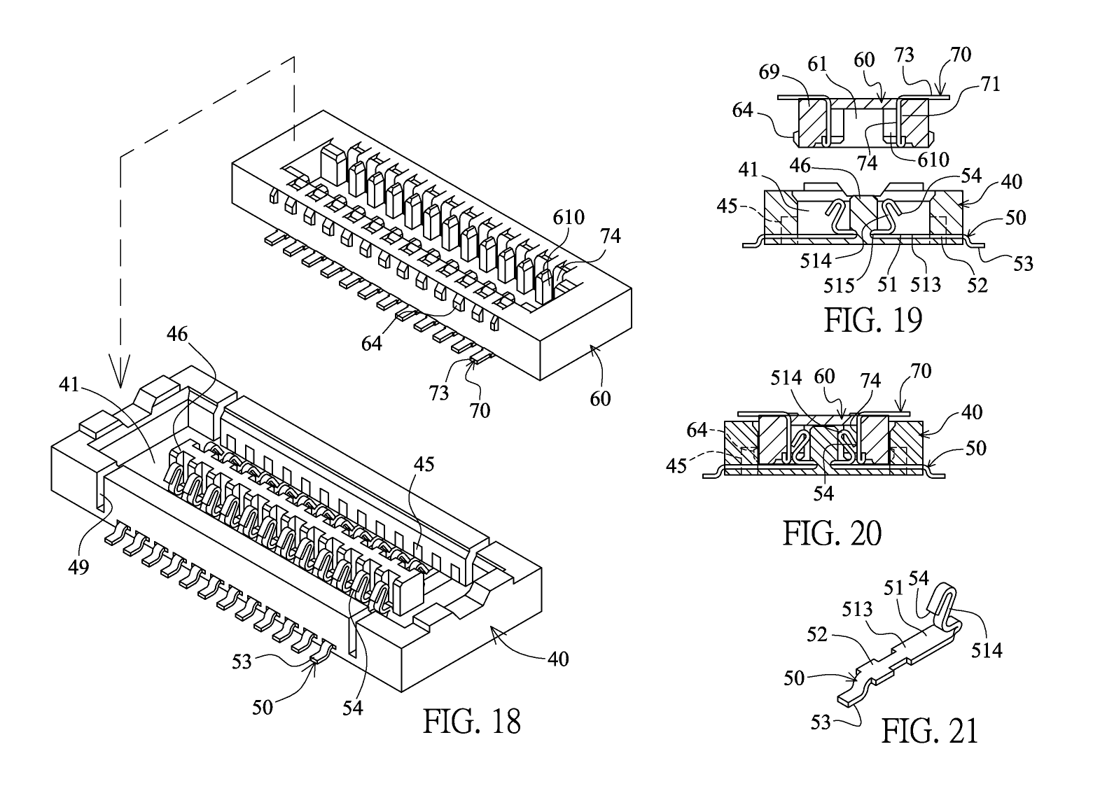

As shown in FIGS. 18 to 21, the seventh embodiment of the invention is substantially the same as the sixth embodiment except that the middle of the female base 40 of this embodiment has a projecting middle portion 46, so that the fitting slot 41 comprises two concave portions on two sides of the middle portion. The middle of the male base 60 has a concave portion 61 so that the two sides are formed with convex portions 69. Each of two sides of the concave portion 61 is formed with one row of slots 610. The concave portion 61 of the male base corresponds to and is fit with the middle portion 46 of the female base 40. The convex portion 69 on two sides of the male base corresponds to and is fit with the fitting slot 41 of the female base in the form of two concave portions. The first portion 513 of the extension 51 of the female terminal 50 extends to the middle portion 46. The second portion 514 is first bent reversely upwards from one end of the first portion 513, and then bent reversely and outwardly downwards to form the laterally and elastically movable force arm. The distal-end cut surface of the extension 51 is the contact 54. The second portion 514, which most projecting outwards, is the contact 54. The connection ends of the first and second portions 515 of the extension 51 are stacked and embedded into the middle portion 46 of the female base 50 and are fixed. The extension 71 of the male terminal 70 is also the fixing portion fixed to the male base 60. The extension 71 has a vertical section and an end section bent reversely. The inner plate surface of the vertical section is the contact 74. The end section of the extension 71 is bent reversely so that the lower end is the plate surface but is not the cut surface.

As shown in FIG. 20, when the male base 60 is combined with the female base 40, the contact 74 of the male terminal 70 laterally and elastically rests against the contact 54 of the female terminal 50, and the second portion 514 of the female terminal 50 is elastically and inwardly movable.

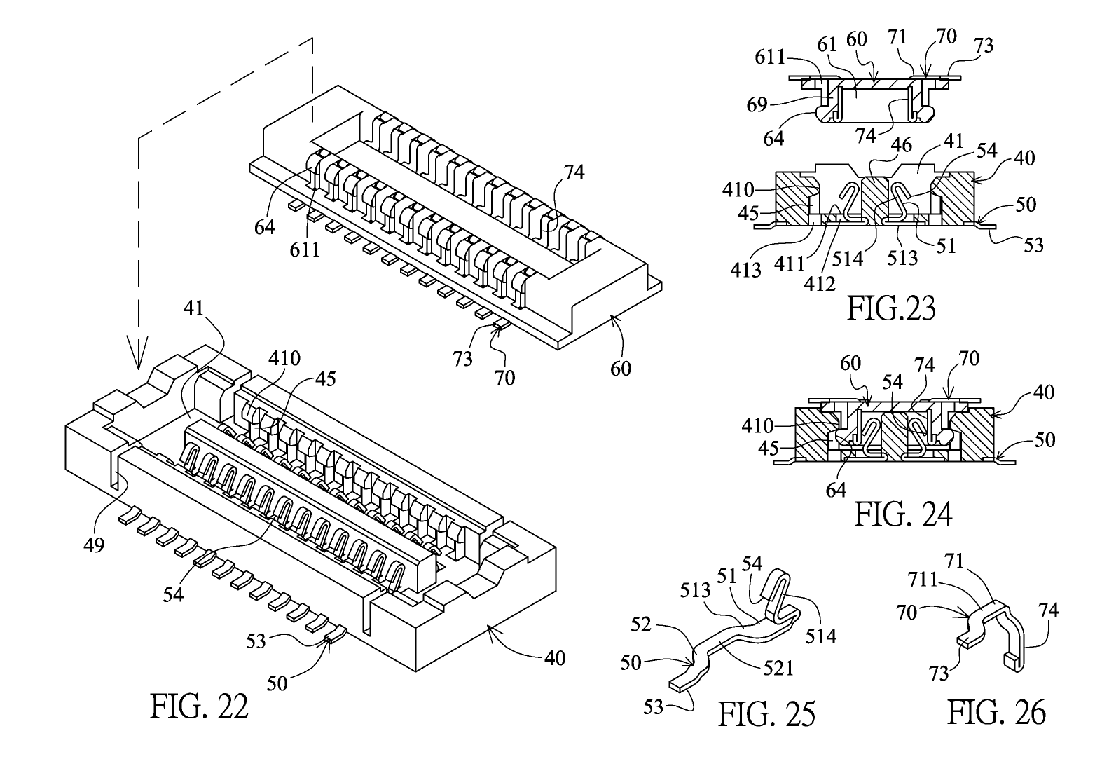

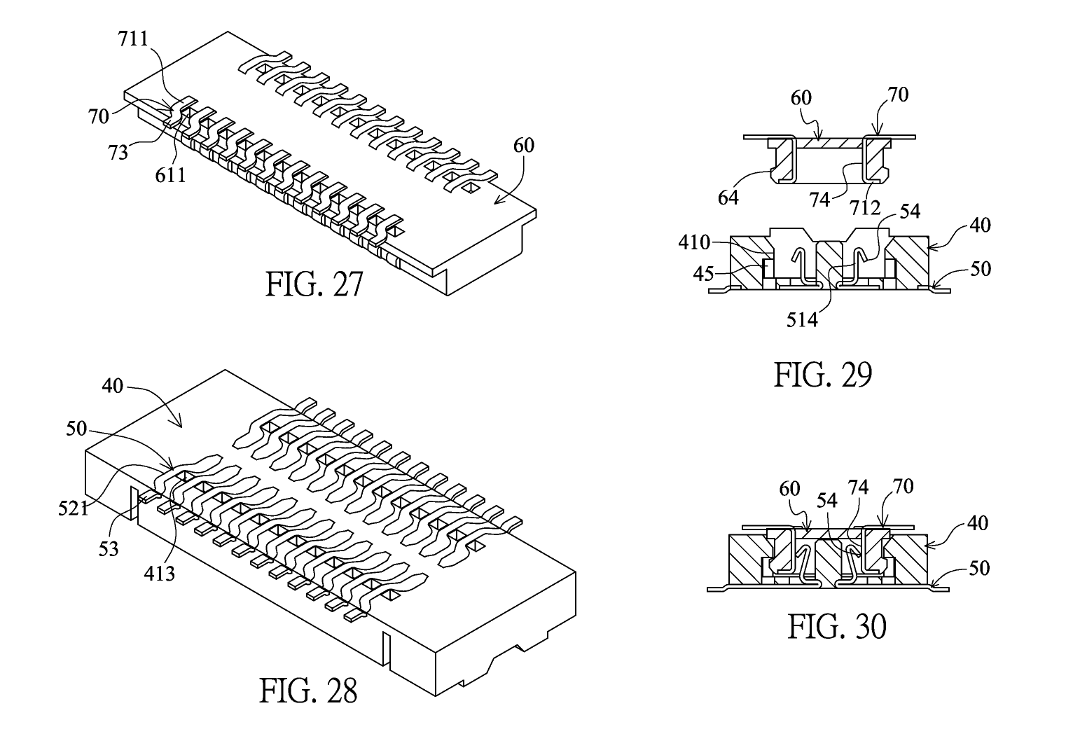

As shown in FIGS. 22 to 28, the eighth embodiment of the invention is substantially the same as the seventh embodiment except that each of two sides of the fitting slot 41 of the female base 40 of this embodiment is formed with one row of projections 410. The bottom of the projection 410 is formed with a transversal fitting concave portion 45. The concave portions 45 transversally correspond to the extensions 51 of the female terminals 50 and are vertically staggered with the fixing portion 52 of the female terminals 50. The concave portions 45 are formed with through holes 413 vertically corresponding to the bottom surface of the female base 40. The fixing portion 52 of the female terminal 50 has the turning portion 521 disposed in the gap between the adjacent through holes 413. The turning portions 521 and the extensions 51 are transversally staggered without overlapping. The bottom plate surface of the first portion 513 of the extension of the female terminal 50 is flush with the bottom surface of the female base 40. Thus, the empty region of each female terminal 50 is lower than the bottom surface of the fitting slot 41. The female base 40 has partition baffles 411 for partitioning the portions of the empty region of each female terminal 50 lower than the fitting slot 41 into slots 412. The partition baffles 411 can strengthen the structure of the female base. The transversally projecting projections 64 of the male base 60 transversally correspond to the contacts 74 of the male terminals 70 and are vertically staggered with the male terminals 70. The transversally projecting projections 64 are formed with through holes 611 vertically corresponding to the male base. The extension 71 of the male terminal 70 has a horizontal turning portion 711 and is disposed in the gap between the adjacent through holes 611. The turning portion 711, the contact 74 and the pin 73 are transversally staggered without overlapping.

According to the above-mentioned structure, this embodiment further achieves the following effects.

First, the male base 60 and the male terminal 70 may be injected molded by combing the top and bottom molds, and the engaging block 64 transversally corresponds to the contact 74 of the male terminal 70. The female base 40 and the female terminal 50 may also be injected molded by combining the top and bottom molds, and the concave portion 45 transversally corresponds to the contact 54 of the female terminal 50. Thus, the male and female connectors of this embodiment can be connected to the conventional male and female connectors.

Second, the bottom plate surface of the first portion 513 of the extension of the female terminal 50 is flush with the bottom surface of the female base 40, so that the height of the female base 40 can be decreased.

Third, the female base 40 has the partition baffles 411 for partitioning the empty region of the each female terminal 50 and strengthening the structure of the female base.

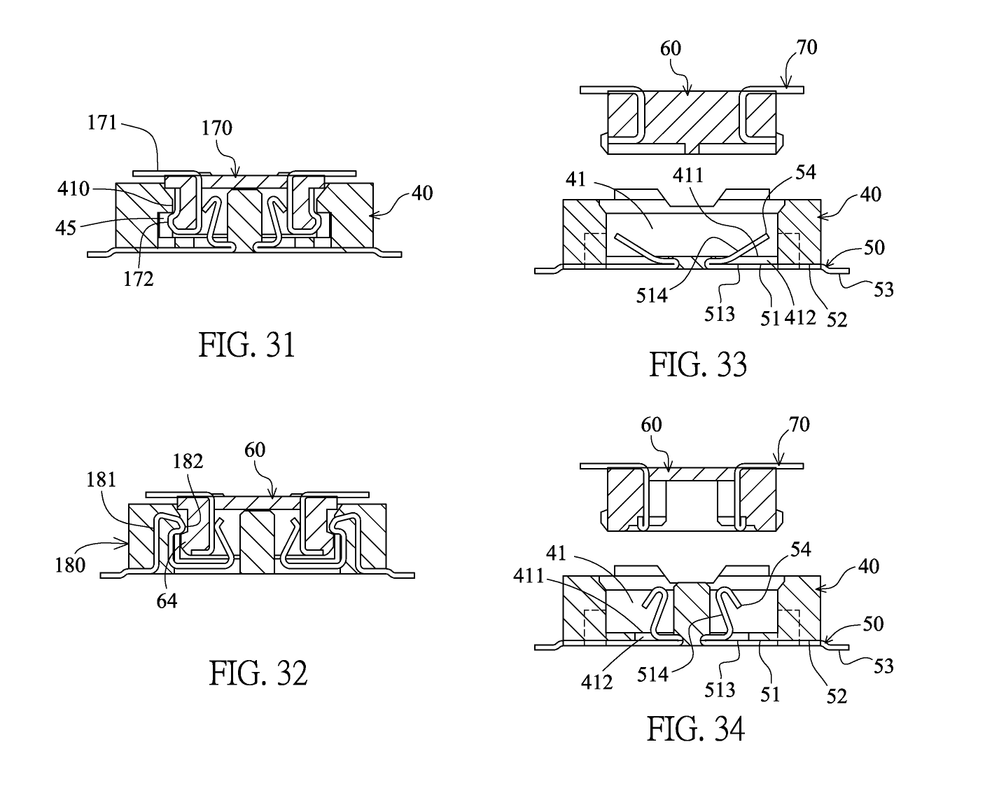

As shown in FIGS. 29 and 30, the ninth embodiment of the invention is substantially the same as the eight embodiment except that the engaging block 64 of the male base 60 of this embodiment vertically corresponds to the top surface of the male base 60. Thus, a slider is needed upon injection molding using top and bottom molds combined together. In addition, the rear section 712 of the extension of the male terminal is bent to be horizontal.

As shown in FIG. 31, when the female connector of this embodiment is connected to the conventional male connector 170, the engaging block 172 of the male terminal 171 of the conventional male connector 170 can be transversally engaged into the concave portion 45 of the female base 40 of this embodiment.

As shown in FIG. 32, when the male connector of this embodiment is connected to the conventional female connector 180, the transversally projecting engaging block 182 of the female terminal 181 of the conventional female connector 180 may be engaged with the top of the projection 64 of the male base 60 of this embodiment.

As shown in FIG. 33, the tenth embodiment of the invention is substantially the same as the sixth and eighth embodiments.

As shown in FIG. 34, the eleventh embodiment of the invention is substantially the same as the seventh and tenth embodiments.

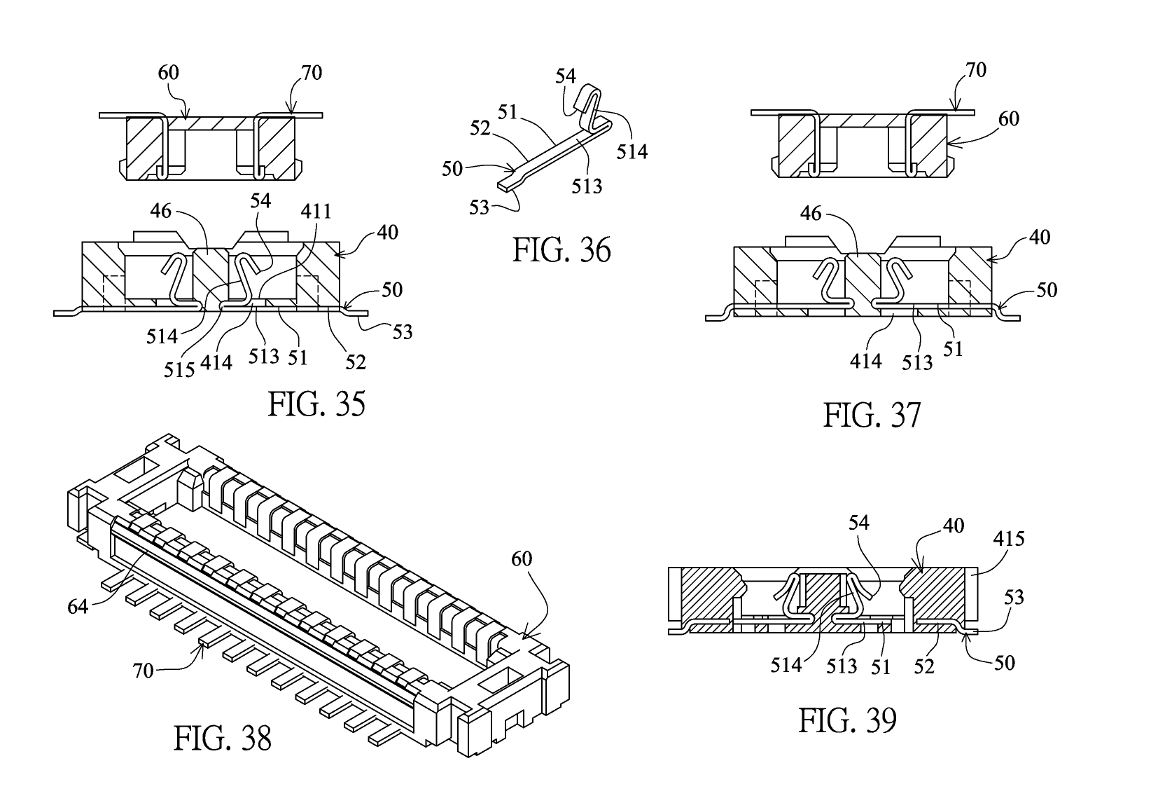

As shown in FIGS. 35 and 36, the twelfth embodiment of the invention is substantially the same as the eleventh embodiment except that the first portion 513 of the extension of the female terminal 50 and the plate surface of the second portion 514 of this embodiment have the same width. The empty region of each female terminal 50 has no bottom surface and is formed with through holes. The female base 40 has partition baffles 411 for partitioning the empty region of the each female terminal 50 to form through holes 414.

As shown in FIG. 37, the thirteenth embodiment of the invention is substantially the same as the twelfth embodiment except that the bottom plate surface of the first portion 513 of the extension of the female terminal 50 of this embodiment is higher than the bottom surface of the female base 40.

As shown in FIG. 38, the 14th embodiment of the invention is substantially the same as the ninth embodiment except that the engaging block 64 of the male base 60 of this embodiment is projectingly disposed on two sides and integrally longitudinally horizontally extends between one row of male terminals 70, so that the manufacturing processes are simplified.

As shown in FIG. 39, the 15th embodiment of the invention is substantially the same as the ninth embodiment except that the rear section of the second portion 514 of the extension of the female terminal 50 of this embodiment is bent downwardly and reversely, stacked and then open with an inclined angle. Similarly, the distal end is formed with the contact 54. In addition, two sides of the female base have partition baffles 415 to strengthen the structure.

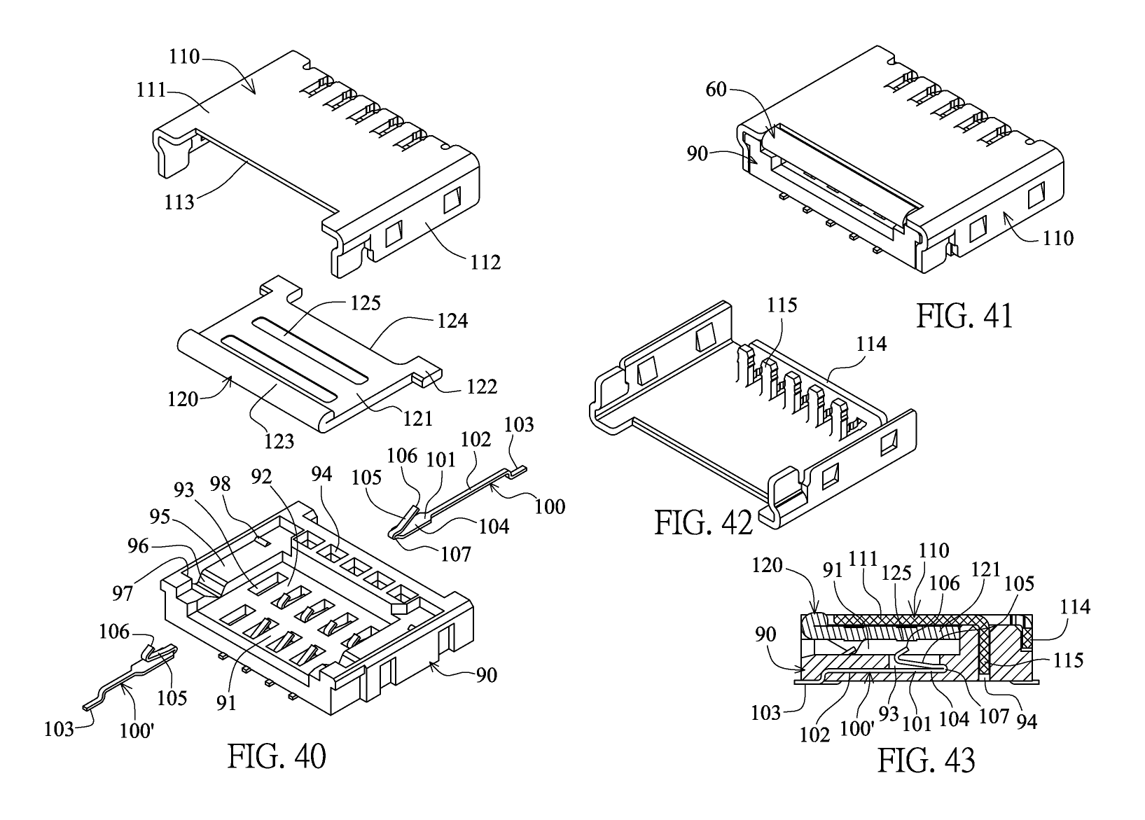

As shown in FIGS. 40 to 43, the electrical connector according to the 16th embodiment of the invention is connected to a bus line or a flexible circuit board and includes a base 90, terminals 100 and 100′, an upper metal cover 110 and a pressing member.

The base 90 is made of a plastic material and has a depressed fitting slot 91. The fitting slot 91 extends to the front end of the base 90 and is open and in the form of an inlet facing frontwards. Two rows of front-to-rear staggered slots 93 are disposed on the bottom surface of the fitting slot 91. The adjacent slot 93 is partitioned by the partition baffle 92. One row of longitudinal positioning slots 94 are disposed in back of the fitting slot 91 and near the back end of the fitting slot 91. The extending direction of the longitudinal positioning slot 94 is perpendicular to the bottom surface of the fitting slot 91. The one row of longitudinal positioning slots 94 and the rear row of slots 93 are front-to-rear staggered. That is, a longitudinal positioning slot 94 is disposed between any two adjacent rear rows of slots 93. Two sides of the fitting slot 91 are formed with the higher sliding slots 95. A stop surface 97 and a downward concave portion 96 are disposed near the front end of the sliding slot 95. The rear section of the sliding slot 95 has an upward convex portion 98.

The terminals are arranged on the base 90 with the terminal gap of 0.3 mm. Each terminal is partially embedded into the base 90 and integrally injection molded. The terminals comprise one row of terminals 100 having rear output pins and one row of terminals 100′ having front output pins. Each of the one row of terminals 100 and the one row of terminals 100′ has the terminal gap of 0.6 mm. The one row of terminals 100 and the one row of terminals 100′ are arranged alternately, so the overall terminal gap is equal to 0.3 mm. The terminal 100 is formed by bending the plate surface of the metal sheet, and is integrally formed with an extension 101, a fixing portion 102 and a pin 103. The fixing portion 101 transversally and horizontally extends and is embedded into the plastic base 30 and fixed. The extension 101 has a first portion 104 and a second portion 105. One end of the first portion 104 is connected to one end of the fixing portion 102 and transversally horizontally frontwardly extends through the front end of one slot 93 of the front row of the base 90. The second portion 105 is bent reversely from the other end of the first portion 104, is inclined upwardly and extends from the slot 93 to the fitting slot 91. The connection ends of the first and second portions 107 are stacked and embedded into the base 90 and fixed. The reversely bent second portion 105 is in the form of an inclined force arm, which is vertically elastically movable in the slot 93 and has an distal-end cut surface that is most convex upward the contact 106. The plastic base has an empty region above the first portion 104 vertically corresponds to the elastically movable portion of the second portion 105. The maximum width of the first portion 104 is greater than the maximum width of the second portion 105. The first portion 104 can vertically completely cover the elastically movable portion of the second portion 105. Two sides of the first portion 104 are covered by the plastic base so that the empty region is formed with a bottom surface flush with the first portion 104. The bottom surface of the empty region is the bottom surface of the slot 93. The end section of the pin 103 horizontally extends out of the back end of the base 90. The terminal 100′ and the terminal 100 have substantially the same structure except that the end section of the pin 103 of the terminal 100′ horizontally extends out of the front end of the base 90. The second portion 105 of the extension of the terminal 100′ is disposed in the rear row of slot 93 of the base 90. The end section of the second portion 105 is again bent reversely, so the contact 106 of the one row of terminals 100 and the contact 106 of the one row of terminals 100′ are inclined backwards and are arranged alternately in the front-to-rear direction.

The two rows of front-to-rear staggered slots 93 are the elastically movable space of the second portions 105 of the two rows of terminals 100 and 100′, respectively.

The upper metal cover 110 is assembled with and fixed to the base 90, and has a top surface 111 and two side surfaces 112 to form an inverse U shape. The front end of the top surface 111 has a notch 113, and the back end of the top surface 111 is bent downwardly to form a rear surface 114. The plate surface of the rear section of the top surface 111 prodded vertically bent downwardly to form one row of longitudinal positioning sheets 115, which are engaged with one row of longitudinal positioning slots 94 of the base 90. The top surface 111 is disposed above the fitting slot 91, so that the front end of the fitting slot 91 is formed with an insertion port, into which a bus line or a flexible circuit board may be inserted.

The pressing member is disposed between the base 90 and the upper metal cover 110. The pressing member is a sliding plate 120 capable of sliding in the front-rear direction relatively to the base 90. The sliding plate 120 is formed by bending a metal plate sheet to form a flat-body like pressing portion 121. Two sides of the back end of the pressing portion 121 have backwardly projecting convex portions so that the back end of the pressing portion 121 becomes a concave portion 124. The outer side of the convex portion is formed with a projecting engaging portion 122. The front end of the pressing portion 121 is formed by folding a metal plate sheet to form a thicker operation portion 123. The plate surface of the pressing portion 121 is downwardly pressed to form two ribs 125. Two sides of the pressing portion 121 rest against the sliding slot 95 of the base 90. When the sliding plate 120 slides the innermost end of the sliding slot 95, the operation portion 123 is still exposed outside the upper metal cover 110 and connected to the notch 113, and the engaging portion 112 can be positioned at the back end of the convex portion 98. When the sliding plate 120 slides out, the stop surface 37 of the base 90 can stop the engaging portion 122.

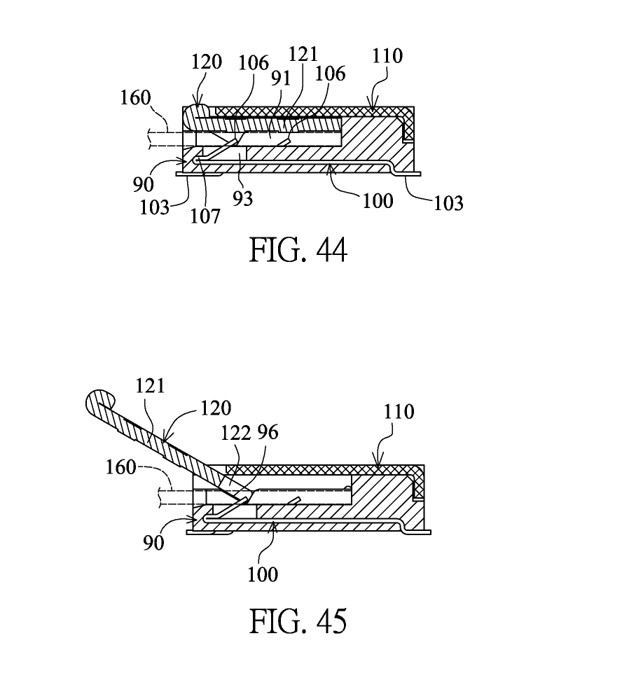

According to the above-mentioned structure, as shown in FIG. 44, the bus line or flexible circuit board 160 can be inserted from the front end of the base 90 into the fitting slot 91 for electrical connection. When the sliding plate 120 slides into the fitting slot 91, the pressing portion 121 tightly rests against the bus line or flexible circuit board 160. As shown in FIG. 45, when the sliding plate 120 slides out, the engaging portion 122 falls into the concave portion 96 so that the sliding plate 120 can be lifted upwards and the pressing portion 121 cannot press the bus line or flexible circuit board 160. At this time, the bus line or flexible circuit board 160 can be frontwardly taken out.

In addition, the electrical connector may also have the single-row terminal configuration having one row of terminals having only rear output pins.

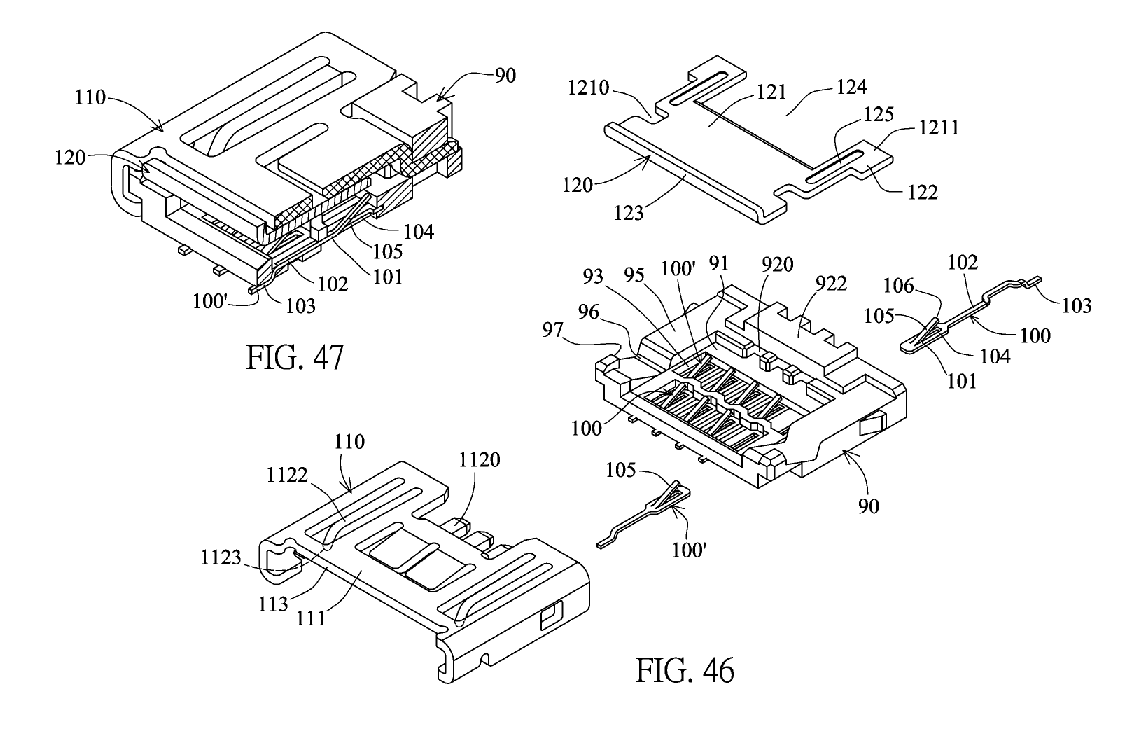

As shown in FIGS. 46 to 50, the 17th embodiment of the invention is substantially the same as the 16th embodiment except that the middle of the rear section of the base 90 has an upward convex surface 922. Three horizontal positioning slots 920 are formed below the convex surface 922.

The upper metal cover 110 is assembled and positioned on the base 90 from front to rear. The rear section of the top surface 111 of the upper metal cover 110 is pressed and bent downwardly by a height to form three horizontal positioning sheets 1120 horizontally backwardly extended and engaged with three horizontal positioning slots 920. Each of two sides of the top surface 111 is pressed to form a front-to-rear extending elastic sheet 1122. The front end 1123 of the elastic sheet 1122 is inclined downwards and bent into the concave portion 96 of the base 90.

The second portions 105 of the extensions 101 of the two rows of terminals 100 and 100′ are prodded from the plate surface of the first portion 104 and slantingly projects upwards. The second extensions 105 of the two rows of terminals 100 and 100′ extends forwards and backwards along the inserting direction of the bus line. The top surfaces of the first portions 104 of the two rows of terminals 100 and 100′ are flush with the bottom surface of the slot 93, and the bottom surface and peripheral sides thereof are embedded and fixed into the base 90, and are thus covered and fixed by the material of the base. The portions of the two slots 93 vertically corresponding to the second portions 105 are empty.

Each of two sides of the front section of the pressing portion 121 of the sliding plate 120 is formed with an engagement hole 1210. The convex portion 1211 projects backwardly by a greater length, so the convex portion 1211 has the reinforcing rib 125.

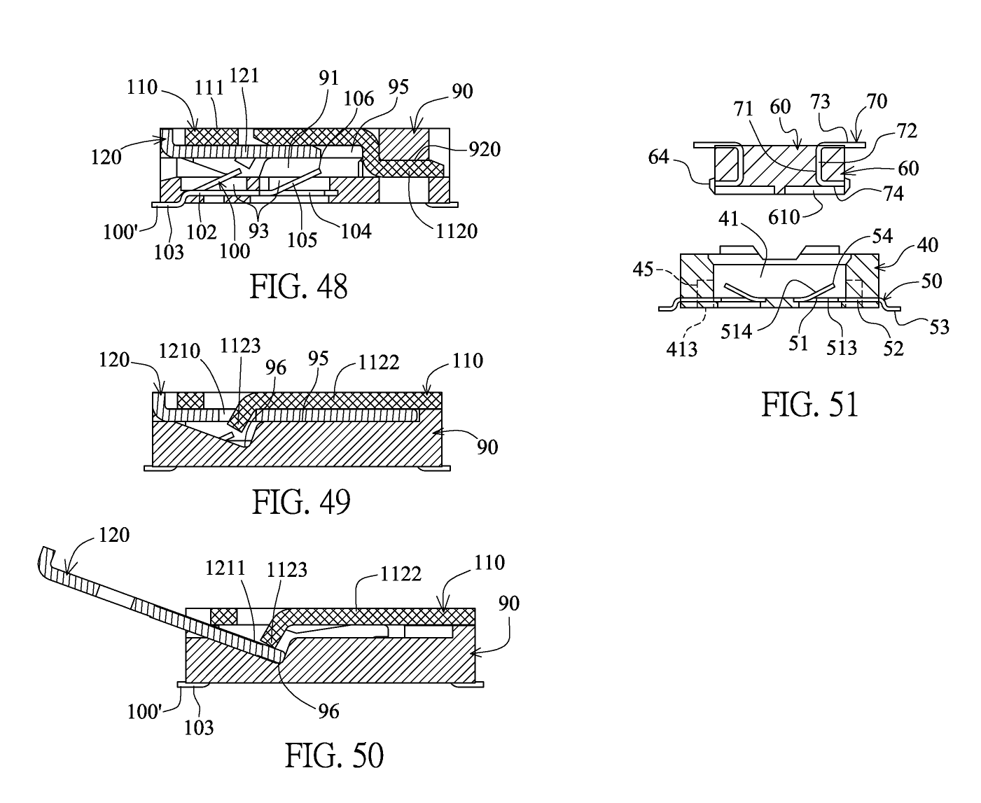

As shown in FIGS. 48 and 49, when the sliding plate 120 is inserted into the fitting slot 91, the front end 1123 of the elastic sheet 1122 is engaged into the engagement hole 1210 and locks with the sliding plate 120. As shown in FIG. 50, when the sliding plate 120 is pulled out of the fitting slot 91, the convex portion 1211 on the back end of two sides of the sliding plate 120 is moved to the concave portion 96 and is downwardly pressed down by the front end 1123 of the elastic sheet so that the sliding plate 120 is in an upward tilted state.

As shown in FIG. 51, the 18th embodiment of the invention is substantially the same as the sixth embodiment except that the embedding and injection molding structure of the female terminal 50 and the female base 40 is the same as the 17th embodiment. That is, the second portion 514 of the extension 51 of the female terminal 50 is formed by prodding the plate surface of the first portion 513 upwardly and projectingly.

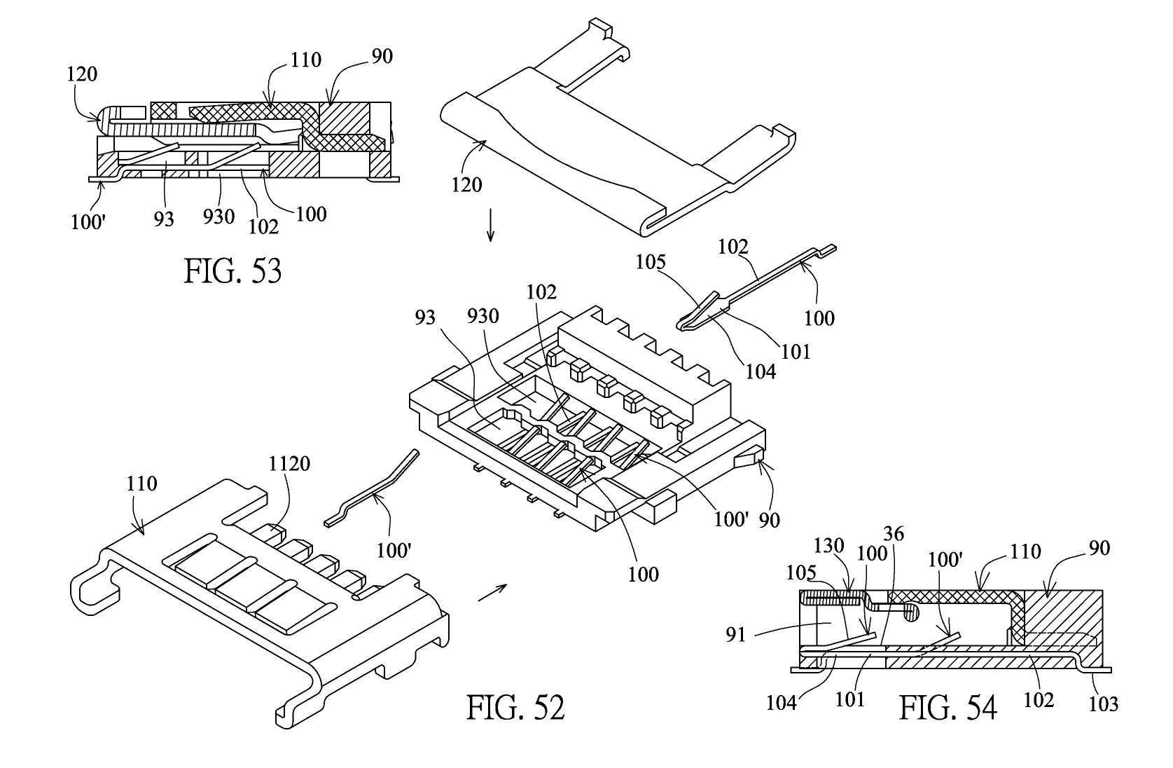

As shown in FIGS. 52 and 53, the 19th embodiment of the invention is substantially the same as the 16th embodiment except that the overall length of one row of terminals 100′ having front output pins is substantially the same as the plate width. The two rows of terminals 100 and 100′ and the insulation base 30 are embedded and injection molded. The front section of the fitting slot 91 of the base 90 is a slot 93, the bottom surface thereof is combined with the first extension 104 of the terminal 100, and the rear section thereof is a through hole 930. However, the front and back ends of the through hole 930 are still combined through the fixing portions 102 of the one row of terminals 100 having rear output pins to enhance the structural strength.

As shown in FIG. 54, the 20th embodiment of the invention is substantially the same as the 19th embodiment except that the pressing member is a pivot member 130 formed by bending a metal plate. The front ends of the first portions 104 of one row of terminals 100 having rear output pins are combined and fixed with the base 90 and are flush with the bottom surface of the fitting slot 91. Partitions 36 are provided to partition the adjacent terminals. The first portion 104 extends to the frontmost end of the base 90 so that the second portion 105 has the longer force arm.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. An electrical connector, comprising:
a female base, which is an insulation material and has a middle formed with a depressed fitting slot;
female terminals arranged on at least one side of the female base, wherein the female terminal is made of a metal sheet and integrally formed with an extension, a fixing portion and a pin, the fixing portion is fixed to the female base, the extension has a contact disposed in the fitting slot, and the pin extends out of the female base;
a male base, which is made of an insulation material and mounted in the fitting slot of the female base; and
male terminals arranged on at least one side of the male base, wherein the male terminal is made of a metal sheet and integrally formed with an extension, a fixing portion and a pin, the fixing portion is fixed to the male base, the extension has a contact elastically resting against the contact of the female terminal, and the pin extends out of the male base;
wherein elastic resting between a plate surface and a cut surface is present between the contacts of the male and female terminals, one of the contacts of the male and female terminals is the plate surface, the other of the contacts of the male and female terminals is the cut surface, one end of the extension of one of the male and female terminals is connected to one end of the fixing portion of the terminal, and the extension is elastically and vertically movable, and has an end section formed with the contact, which is vertically projecting.

2. The electrical connector according to claim 1 having the features selected from one or more than one of the group consisting of:
(a) the at least one side of the female base is formed with female terminal slots, in which the female terminals are mounted;
(b) the at least one side of the male base is formed with male terminal slots, in which the male terminals are mounted;
(c) the female terminal is formed by bending the plate surface;
(d) the male terminal is formed by bending the plate surface;
(e) at least one of the male and female terminals is formed by bending the plate surface and has the fixing portion transversally fixed;
(f) the fitting slot of the female base is a single concave portion, and the male base is a single convex portion;
(g) the extension of the female terminal is elastically and vertically movable and has the contact most convex toward the fitting slot, and the extension of the male terminal is not elastically movable; and
(h) the female base has a vertical limiting surface, and the extension of the female terminal rests against the limiting surface or rests against the limiting surface when elastically movable.

3. An electrical connector, comprising:
a female base, which is made of an insulation material and has a middle formed with a fitting slot;
female terminals arranged on at least one side of the female base, wherein the female terminal is made of a metal sheet and integrally formed with an extension, a fixing portion, and a pin, the fixing portion is fixed to the female base, the extension has a contact disposed in the fitting slot, and the pin extends out of the female base;
a male base is made of an insulation material and mounted in the fitting slot of the female base; and
male terminals arranged on at least one side of the male base, wherein the male terminal is made of a metal sheet and integrally formed with an extension, a fixing portion and a pin, the fixing portion is fixed to the male base, the extension has a contact elastically resting against the contact of the female terminal, and the pin extends out of the male base;
wherein at least one of the male and female terminals is formed by bending a plate surface and has the fixing portion transversally fixed.

4. The electrical connector according to claim 3, having the features selected from one or more than one of the group consisting of:
(a) the at least one side of the female base has female terminal slots, the female terminal slot has a transversal fixing slot, and the female terminals are mounted in the female terminal slots and have fixing portions fixed to the fixing slots;
(b) the at least one side of the male base has male terminal slots, the male terminal slot has a transversal fixing slot, and the male terminals are mounted in the male terminal slots and have fixing portions fixed to the fixing slots;
(c) the female terminal is formed by bending the plate surface and has the fixing portion transversally fixed;
(d) the male terminal is formed by bending the plate surface and has the fixing portion transversally fixed;
(e) the male terminal is formed by bending the plate surface and has the fixing portion horizontally fixed;
(f) the female terminal is formed by bending the plate surface and has the fixing portion horizontally fixed;
(g) the fitting slot of the female base is a single concave portion, and the male base is a single convex portion;
(h) the extension of the female terminal is elastically movable and has the contact most convex toward the fitting slot, and the extension of the male terminal is not elastically movable.

5. An electrical connector, comprising:
a female base, which is made of an insulation material and has a middle formed with a fitting slot;
female terminals arranged on at least one side of the female base, wherein the female terminal is made of a metal sheet and integrally formed with an extension, a fixing portion and a pin, the fixing portion is fixed to the female base, the extension has a contact disposed in the fitting slot, and the pin extends out of the female base;
a male base, which is made of an insulation material and mounted in the fitting slot of the female base;
male terminals arranged on at least one side of the male base, wherein the male terminal is made of a metal sheet and integrally formed with an extension, a fixing portion and a pin, the fixing portion is fixed to the male base, the extension has a contact elastically resting against the contact of the female terminal, and the pin extends out of the male base; and
an engaging structure, which makes the male base be combined with and engaged with the female base so that the contact of the male terminal elastically rests against the contact of the female terminal;
wherein the engaging structure has a first engaging portion on two sides of the male base, and is integrally formed with a second engaging portion on two sides of the fitting slot of the female base, the first and second engaging portions are a transversal projection and a concave portion engaging with each other, the contact of the male terminal is disposed on an inner side of the first engaging portion, and the contact of the female terminal is disposed on an inner side of the second engaging portion.

6. The electrical connector according to claim 5, having the features selected from one or more than one of the group consisting of:
(a) the at least one side of the female base is formed with female terminal slots, in which the female terminals are mounted;
(b) the at least one side of the male base is formed with male terminal slots, in which the male terminals are mounted;
(c) the female terminal is formed by bending a plate surface;
(d) the male terminal is formed by bending a plate surface;
(e) at least one of the male and female terminals is formed by bending a plate surface and has the fixing portion transversally fixed;
(f) the fitting slot of the female base is a single concave portion, and the male base is a single convex portion;
(g) the extension of the female terminal is elastically and vertically movable and has the contact most convex toward the fitting slot, and the extension of the male terminal is not elastically movable;
(h) the first engaging portion comprises at least one transversally projecting projection, the second engaging portion comprises at least one transversally fit concave portion, and a vertically corresponding top of the concave portion has a top engaging surface;
(i) each of two ends of one row of female terminals on one side of the female base has a vertically extending groove.

7. The electrical connector according to claim 5, wherein the first engaging portion and the male base are integrally formed jointly with each other.

8. The electrical connector according to claim 5, wherein the first engaging portion comprises transversally projecting projections, the second engaging portion comprises transversally fit concave portions, and a vertically corresponding top of the concave portions has a top engaging surface.

9. The electrical connector according to claim 8, wherein:
(a) the fixing portion of each of the female terminals is embedded into the female base and is integrally injection molded, the concave portions transversally correspond to gaps between the adjacent female terminals, and a bottom surface of the base of a vertically corresponding bottom of the concave portions is formed with through holes;
(b) the fixing portion of each of the female terminals is embedded into the female base and integrally injection molded, and the concave portions transversally correspond to the female terminals;
(c) the fixing portion of each of the female terminals is embedded into the female base and integrally injection molded, the concave portions transversally correspond to the female terminals and are vertically staggered with the female terminals, and the bottom surface of the base of the vertically corresponding bottom of the concave portions is formed with through holes, the fixing portion of the female terminal has a turning portion and is disposed in a gap between the adjacent through holes, the turning portions of the fixing portions of the female terminals are transversally staggered with the extensions without overlapping; or
(d) at least one side of the female base has the female terminal slots, the female terminal slot has a transversal fixing slot, the female terminals are mounted in the female terminal slots and have the fixing portions transversally fixed to the fixing slot, and the concave portion is formed in the female terminal slot and above the fixing slot.

10. An electrical connector, comprising:
a female base, which is made of an insulation material and has a middle formed with a fitting slot;
female terminals, which is arranged on at least one side of the female base, wherein the female terminal is made of a metal sheet and integrally formed with an extension, a fixing portion and a pin, the fixing portion is fixed to the female base, the extension has a contact disposed in the fitting slot, and the pin extends out of the female base;
a male base, which is made of an insulation material and mounted in the fitting slot of the female base;
male terminals arranged on at least one side of the male base, wherein the male terminal is made of a metal sheet and integrally formed with an extension, a fixing portion and a pin, the fixing portion is fixed to the male base, the extension has a contact elastically resting against the contact of the female terminal, and the pin extends out of the male base; and
an engaging structure, which makes the male base be combined and engaged with the female base so that the contact of the male terminal elastically rests against the contact of the female terminal;
wherein the engaging structure is integrally formed with a first engaging portion on two sides of the male base, the first engaging portion comprises at least one transversally projecting projection, and the contact of the male terminal is disposed on an inner side of the first engaging portion.

11. The electrical connector according to claim 10, wherein:
(a) the at least one projection comprises projections, at least one side of the male base has male terminal slots, the male terminals are mounted in the male terminal slots, and each of the projections vertically corresponds to one male terminal;
(b) the fixing portion of each of the male terminals is embedded into the male base and integrally injection molded, the at least one projection comprises projections transversally corresponding to gaps between the adjacent male terminals, and the male base is vertically staggered with the projections;
(c) the fixing portion of each of the male terminals is embedded into the male base and integrally injection molded, the at least one projection comprises projections transversally corresponding to the male terminals and is vertically staggered with the male terminals; or
(d) the at least one projection longitudinally and horizontally extends between one row of male terminals.

12. An electrical connector, comprising:
a base, which is made of an insulation material and has a fitting slot; and
terminals arranged on the base, wherein the terminal is formed by bending a metal sheet and is integrally formed with an extension, a fixing portion and a pin, wherein the fixing portion is fixed to the base, the extension is connected to one end of the fixing portion and has a projecting contact disposed in the fitting slot, and the pin is connected to the other end of the fixing portion and extends out of the base;
wherein the fixing portions of at least one row of terminals are embedded into the base and are integrally injection molded, the extensions of the one row of terminals have first portions and second portions, the first portions extend transversally, one end of the first portion is connected to one end of the fixing portion, the other end of the first portion is embedded into the base and fixed, the second portion extends to the fitting slot and vertically corresponds to the first portion, the second portion is elastically movable and has the contact, and the base has an empty region above the first portion vertically corresponding to an elastically movable portion of the second portion.

13. The electrical connector according to claim 12 being a female connector of a board-to-board connector, wherein the fitting slot is disposed at a middle of the base and is downwardly depressed, an inlet of the fitting slot faces upwards, the terminals are arranged on two sides of the base, and the fitting slot can be fit with a male connector for electrical connection.

14. The electrical connector according to claim 12 being an electrical connector connected to a bus line or a flexible circuit board, wherein an inlet of the fitting slot faces frontwards, the second portions of the terminals are elastically and vertically movable, the terminals are two rows of terminals having front and rear output pins and arranged alternately, or one row of terminals having rear output pins.

15. The electrical connector according to claim 12, wherein the second portion is bent and reversely extends to the fitting slot from one end of the first portion away from one end of the fixing portion, a maximum width of the first portion is greater than or equal to a maximum width of the second portion, the first portion can vertically completely cover the elastically movable portion of the second portion, two sides of the first portion are covered by a material of the base, and the empty region is formed with a bottom surface and flush with the first portion.

16. The electrical connector according to claim 15, having the features selected from one or more than one of the group consisting of:
(a) the base has partitions for partitioning portions of the empty region lower than the fitting slot into slots; and
(b) a bottom plate surface of the first portion is flush with a bottom surface of the base.

17. The electrical connector according to claim 12, wherein the second portion is bent reversely and extends to the fitting slot form one end of the first portion away from the fixing portion, the base has at least one through hole, and the at least one through hole vertically corresponds to the elastically movable portion of the second portions of the terminals.

18. The electrical connector according to claim 12, wherein the second portion is prodded from a middle of a plate surface of the first portion and slantingly projects upwardly toward the fitting slot, a bottom surface and peripheral sides of the first portion are covered and fixed by a material of the base, the empty region is formed with a bottom surface and flush with the first portion, and a corresponding bottom of the second portion is formed with through holes.

19. The electrical connector according to claim 14, having the features selected from one or more than one of the group consisting of:
(a) the second portion of the extension of the terminal extends forwards along an inserting direction;
(b) the contact of the terminal is disposed on a cut surface of a distal end of the second portion;
(c) front ends of the first portions of the extensions of the one row of terminals having rear output pins are fixed to the base and flush with a bottom surface of the fitting slot; and
(d) the second portions of the terminals have at least one through hole or slot for elastic movement corresponding to a bottom surface of the fitting slot.

20. The electrical connector according to claim 12, having the features selected from one or more than one of the group consisting of:
(a) the fixing portion of the terminal extends transversally;
(b) the fixing portion and the first portion of the extension of the terminal extend transversally and horizontally;
(c) the contact of the terminal is disposed on a cut surface of a distal end of the second portion; and
(d) the base has partitions for partitioning portions of the empty region lower than the fitting slot into slots or through holes.
